(19) United States
(12) Patent Application Publication
(10) Pub. No.: US 2012/0317306 A1
(43) Pub. Date: Dec. 13, 2012

(54) Statistical Network Traffic Signature Analyzer

(75) Inventors: Kira Radinsky, Zichron Yaakov (IL); Evgeney Ryzhyk, Herzliya (IL); Moshe Golan, Haifa (IL)

(73) Assignee: MICROSOFT CORPORATION, Redmond, WA (US)

(21) Appl. No.: 13/157,316

(22) Filed: Jun. 10, 2011

(51) Int. Cl. G06F 15/16

(52) U.S. Cl. 709/235

(57) ABSTRACT

A network traffic analyzer may identify applications transmitting information across a network by analyzing various protocol attributes of the communication. A set of signatures may be created by training a machine learning system using network traffic with and without a specific application. The machine learning system may generate a signature for the specific application, and the signature may be analyzed using a monitoring system to identify the presence of the application's traffic on the network. In some embodiments, a decision tree may be used to detect the application within a statistical confidence. The monitoring system may be used for malware detection as well as other applications.

### BACKGROUND

Network traffic may be analyzed by examining packets of information being transmitted, and examining the contents of those packets. Such an analysis may be useful in some cases where the packets are well formed and stable, and the analysis may correctly identify the originating application. Often, such analysis may be performed to identify malicious software.

### SUMMARY

A network traffic analyzer may identify applications transmitting information across a network by analyzing various protocol attributes of the communication. A set of signatures may be created by training a machine learning system using network traffic with and without a specific application. The machine learning system may generate a signature for the specific application, and the signature may be analyzed using a monitoring system to identify the presence of the application's traffic on the network. In some embodiments, a decision tree may be used to detect the application within a statistical confidence. The monitoring system may be used for malware detection as well as other applications.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a network environment with devices that detect and identify applications.

FIG. 2 is a flowchart of an embodiment showing a method for creating signatures for new applications.

FIG. 3 is a flowchart of an embodiment showing a method for identifying and monitoring applications.

### DETAILED DESCRIPTION

A network traffic analyzer may identify an application's network traffic with a statistical confidence interval using signatures generated by machine learning. The signatures may be generated by training the machine learning system using network traffic with and without the application's traffic. Each application that may be tracked may have its own signature created.

A monitoring application may analyze network traffic by gathering packets transmitted over the network, generating a signature for those packets, and analyzing the current network signature using each of the predefined signatures for known applications. The monitoring application may identify the presence of one or more of the known applications, then cause some action to be taken.

In one embodiment, signatures for known computer viruses or other malware may be generated. The signatures may be used by a monitoring system to analyze network traffic on an ongoing basis to detect malware. Once the malware is detected with a predefined level of certainty, a user or administrator may take appropriate action, such as monitoring the malware or shutting down the application or device. Other embodiments may identify various applications for network load balancing and other uses.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

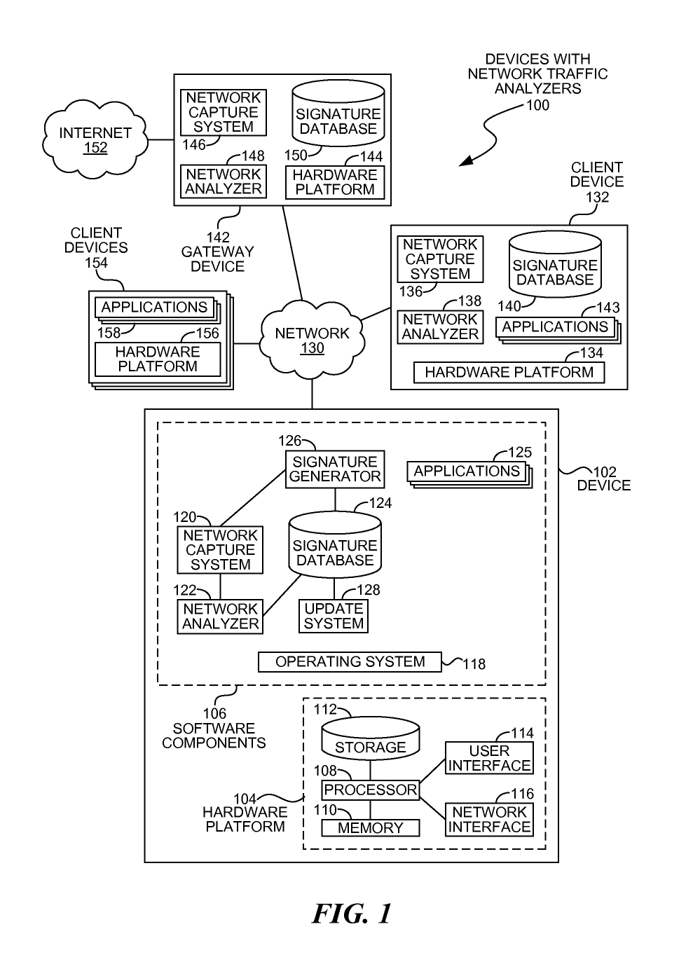

FIG. 1 is a diagram of an embodiment 100, showing a system for creating and using network transmission signatures to identify applications transmitting on a network. Embodiment 100 is a simplified example of a system that may generate signatures as well as some embodiments where a detection system may be used.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is a simplified example of a network environment in which applications may be detected by their network transmission signatures. Applications may be detected for several use scenarios, such as malware detection and network traffic management. Applications may be detected by a signature created by monitoring network packets associated with an application and creating a vector representing several descriptive parameters of the packets. A detection system may use decision trees or other signatures to identify various applications.

In a typical use scenario, a monitoring system may monitor network traffic to detect malware. In such a use scenario, the monitoring system may be arranged on a network gateway to monitor network traffic in and out of a local area network, or may be arranged on a client device to monitor network traffic in and out of the client device.

When monitoring malware, the monitoring system may have a signature database that includes signatures from many viruses, bots, or other malware. The monitoring system may track network sessions and compare those sessions to known malware. When malware is detected, the monitoring system may stop the network session, alert a user or administrator, slow down the network session, or perform other actions. In general, such a monitoring system may take action that limits or minimizes the network traffic associated with the network session.

When monitoring network traffic, the monitoring system may have a signature database that includes signatures from various applications, including quality of service critical applications such as Voice over IP (voip), video conferencing, or other time sensitive communications applications. The signature database may also include various applications that consume bandwidth but are not time sensitive. In such a use scenario, a network monitoring system may increase the priority of time sensitive applications and decrease the priority of non-time sensitive applications.

The applications signatures may use a parameter vector that includes many protocol or communication attributes. A parameter vector may include parameters relating to the transport or lower level layers in the Open Systems Interconnection model (OSI model) definitions. Such parameters may include protocol types, such as UDP or TCP. The parameter vector may also include port designations, including source port and destination port. Such parameters may identify different applications. In some cases, certain applications may use a specific source or destination port as part of their normal operations. Some applications may change source or destination ports with each session or as part of a non-standard configuration.

The parameter vector may include parameters regarding the behavior of a session. Such parameters may include the duration of the connection, as well as the volume of information transmitted during a session. Such parameters may include the number of data bytes from the source to the destination, the number of data bytes from the destination to the source, as well as the number of packets from the source to the destination and the number of packets from the destination to the source. The parameters may also include the direction of traffic.

Many applications may have different session behavior. Some malicious software may gather information from a host device and transmit information to a server. In such embodiments, the malicious software may have a behavior that is predominantly transmission with little reception. Other applications, such as audio or video conferencing may have close to the same amount of transmission and reception. In this manner, session behavior may be one indicator that may help identify a specific application.

Some parameter vectors may include sub-flow volume parameters. The sub-flow volume may identify certain communications protocols where a single transmission stream is striped across multiple communications streams. Some embodiments may include summary parameters for sub-flows, such as the number of flows over which a communication may be striped or other summary statistics.

The parameter vector may include the number of packets per active period. Such parameters may include the number of packets transmitted as part of the entire flow or as individual sub-flows.

Some applications may use a PUSH operation, which is part of the TCP protocol. Packets with the PUSH flag set are transmitted without delay. Some applications may use the PUSH flat for some or all of their transmissions and may provide a portion of the signature that may identify the transmitting application.

In some embodiments, various statistics regarding packet transmission may be collected and used as part of the signature of an application. The statistics may include the minimum, mean, average, maximum, standard deviation, or other descriptive characteristics for the packet length, inter-arrival times, and active and idle times. These statistics may help identify an application as each application may process and transmit information in different manners.

For example, some applications may consistently receive and transmit packets that are of a uniform size. Other applications may use packets that vary in size.

In another example, some applications may transmit packets in a relatively uniform frequency while other applications may transmit packets with a widely varying frequency. These characteristics may be used to help identify specific applications.

Some parameter vectors may include various error-related features. For example, some parameter vectors may include a flag denoting a normal or error status of a connection, a percentage of SYN errors, a percentage of REJ errors, or other statistics regarding errors on the transmission. Some embodiments may include the number of connections to the same host as a current connection within a period of time, which may be one or two seconds to several minutes.

In some embodiments, parameters may be extracted from a network session in the form of n-grams, or all the sequences of characters of size n. A parser may analyze sequences of characters for n=3, 4, 5, or more. The n-grams may be analyzed for the content of the communication.

Many embodiments may perform connection analysis over one or more time windows. Some applications may have characteristics that may be identified in a relatively short time windows while other applications may have characteristics that come to light in longer time windows. In many embodiments, analyses may be performed using time windows that are several seconds, minutes, or hours long.

In many embodiments, each parameter may be calculated using a different time window. In such embodiments, some or all of the parameter values may be determined by calculating a minimum and maximum value in a time window, a mean and median value in the time window, and standard deviation within the time window.

The signature analysis may operate by analyzing a communications stream using the various parameters in a parameter vector. Each application may have a signature that may identify the application based on characteristics of that application's network traffic.

An architecture of an example embodiment may have a mechanism for determining a signature for a given application, and a separate monitoring application that may capture and analyze network traffic in real time. The mechanism for determining a signature for a given application may cause an application to execute, then monitor the network communications performed by the application. The data collected may be analyzed using a machine learning algorithm or other mechanism to create a signature. The signature may then be transmitted to the monitoring applications to identify the given application.

Embodiment 100 is an example of a computer network environment in which a signature generator and various monitoring systems may operate. The device 102 represents a device in a network environment that may be used to generate network signatures as well as monitor the network communications to identify specific applications. The device 102 may be made up of a hardware components 104 and various software components 106. The device 102 may be a server computer, but some embodiments may utilize desktop computers, game consoles, and even portable devices such as laptop computers, mobile telephones, or other devices.

The hardware components 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware components 104 may include various peripherals that make up a user interface 114. In some cases, the user interface peripherals may be monitors, keyboards, pointing devices, or other user interface peripherals. Some embodiments may not include such user interface peripherals.

The hardware components 104 may also include a network interface 116. The network interface 116 may include hardwired and wireless interfaces through which the device 102 may communicate with other devices.

The software components 106 may include an operating system 118 on which various applications may execute.

A network capture system 120 may monitor communications over a network and a network analyzer 122 may generate various parameters that make up a parameter vector for each application. The network analyzer 122 may compare the parameter vector to a signature database 124 to identify specific applications based on their network communications.

A signature generator 126 may take network communications gathered for a new application and create a new signature for the application. Once the signature is generated, the signature may be tested and verified, then transmitted to any monitoring application using an update system 128.

The signature generator 126 may execute one or more applications 125 and monitor those application's network transmissions. During the transmission, the data for the application may be identified with the network capture system 120. In many embodiments, an application's network transmissions may be identified as a communication session established by the application or responded to by the application. The packets associated with the communication session may be gathered and analyzed.

In some cases, an application may create two or more communication sessions. Some embodiments may be able to identify multiple communication sessions created by a single application. In such embodiments, a signature for the application may include parameter vectors for one or each of the communication sessions.

The device 102 may operate over a network 130, which may be a local area network. The local area network 130 may be connected to the internet 152 through a gateway device 142.

In some embodiments, monitoring mechanism may be a client application that monitors incoming and outgoing network communications to a specific device. In one such embodiment, the monitoring mechanism may execute on a device and be used to identify malware, for example.

Such a device may be represented by a client device 132. The client device 132 may be any device that has a hardware platform 134 that has a processor. An example may be a personal computer, server computer, game console, mobile telephone, or other device.

The client device 132 may have a network capture system 136 and network analyzer 138 that may monitor network communications, analyze the communications, and implement a course of action when a specific application is identified. The network analyzer 138 may use a signature database 140 that may be updated periodically with new signatures.

In many embodiments, the client device 132 may execute various applications 140. In some cases, the applications 140 may contain malware that may be dangerous software that may cause problems with the client device 132 or with other devices on a network.

In some embodiments, a gateway device 142 may operate a monitoring mechanism that may identify applications based on network traffic passing between the local area network 130 and the Internet 152. In such embodiments, the gateway device 142 may be used to identify malware or other noxious or undesirable applications. In some embodiments, the gateway device 142 may identify applications and change the bandwidth allocations or priorities when certain applications are identified.

In the embodiment of a gateway device 142, a hardware platform 144 may have a processor on which a network capture system 146 may operate with a network analyzer 148 that references a signature database 150. The gateway device 142 may operate by monitoring network traffic passing through the gateway device 142, in contrast to a client device 132 that may monitor network traffic passing into and out from the client device 132 by applications 143 operating on the client device 132.

The gateway device 142 may protect devices inside a local area network, such as client devices 154, for which no anti-malware software or no network monitoring anti-malware software is operating. Such an embodiment may monitor all network traffic to detect if an inappropriate software application is executing and may cause the application's communications to be halted or perform some other operation.

The client devices 154 may operate on a hardware platform 156 on which various applications 158 may execute.

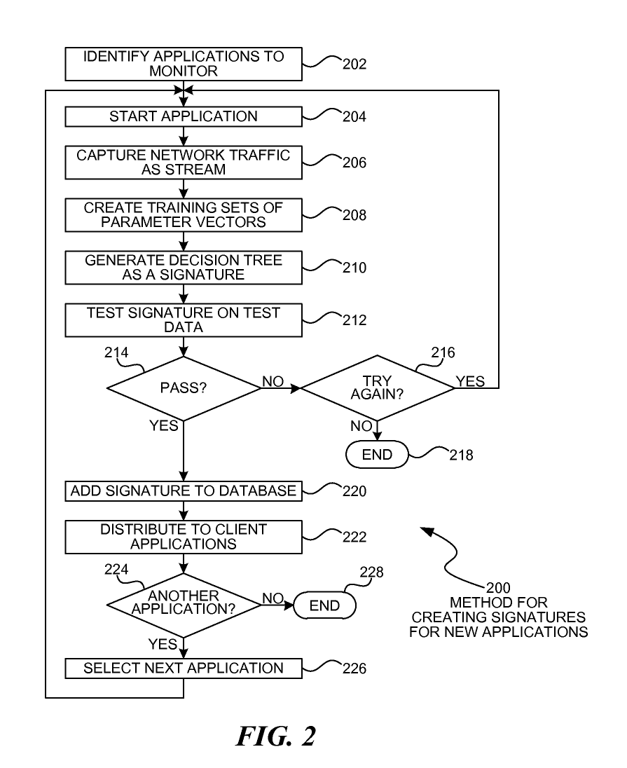

FIG. 2 is a flowchart illustration of an embodiment 200 showing a method for creating application signatures. Embodiment 200 is a simplified example of a method that may be performed by a network capture system, a network analyzer, and a signature generator, such as the network capture system 120, the network analyzer 122, and the signature generator 126 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates one method by which signatures may be created for applications. The signatures may be a decision tree with conditional probabilities. Such signatures may be able to detect a specific application and give a probability of a match for that application.

Embodiment 200 illustrates a method that uses machine learning to compare a first application with a second application. One form of machine learning may be a random forest that has many decision trees, one for each application that may be identified. The decision trees may serve as signatures for the applications that may be identified by the system.

In block 202, the applications for which signatures may be generated may be identified. The application may be a desirable or undesirable application. An undesirable application may be a malicious application, such as a virus, worm, Trojan horse, spyware, scareware, crimeware, rootkits, or other type of application. In such cases, the application may be executed in a contained environment where the application may not be spread to other devices.

The first application may be started in block 204 and network traffic created by the first application may be captured in block 206. In some cases, the application may connect to another computer in a local area network or to a server located outside a local area network. The data captured for the first application may be collected using multiple time frames. Within each time frame, data may be collected and summarized.

From the collected data, a training set may be identified in block 208. The training set may be a parameter vector that includes values for all of the parameters measured in a signature. In some cases, some of the values may be summary statistics, such as averages, minimum and maximum value, standard deviations, or other statistics.

In many embodiments, an estimate of variability may be identified for each of the parameters. The estimate of variability may serve as a bootstrap or accuracy of a sample estimate.

A decision tree may be generated in block 208 using the training set and estimates of variability. The decision tree may serve as a signature for the application.

The decision tree may be tested in block 212 using test data to verify the accuracy of the decision tree.

If the signature does not pass the test in block 214, the process may attempt another try in block 216 and the process may return to block 204. If the signature does not pass the test in block 214 and no further attempts are to be tried in block 216, the process may end in block 218.

If the signature does pass the test in block 214, the signature may be added to the signature database in block 220 and distributed to client applications in block 224.

In many embodiments, client applications may receive updates to the signatures using various distribution models. Some embodiments may use a publication/subscription model where client devices may subscribe to a publication service that contains signature updates. Other embodiments may use a push model where updates are pushed from a central server to client devices.

If another application is to be evaluated in block 224, the next application may be selected in block 226 and the process may return to block 204. If no further applications are to be evaluated in block 224, the process may end in block 228.

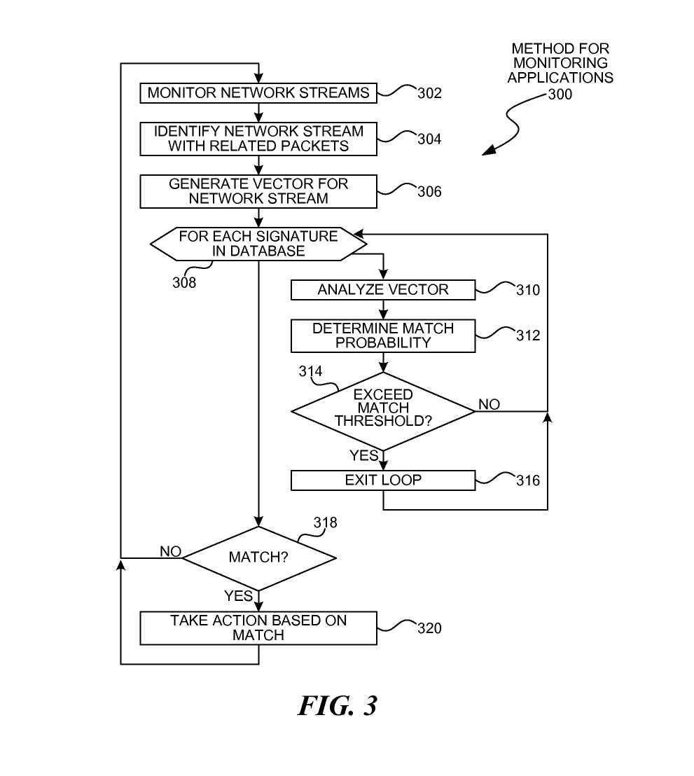

FIG. 3 is a flowchart illustration of an embodiment 300 showing a method for monitoring applications. Embodiment 300 is a simplified example of a method that may be performed by a network capture system and a network analyzer when the system operates in a monitoring mode. The operations may reflect those performed by a network capture system 136 and network analyzer 138 on a client device 132, or by a network capture system 146 and network analyzer 148 of the gateway device 142 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is a simplified example of a system that may use a different signature for each application that may be identified. Such embodiments may be implemented as a random forest technique for identification.

Embodiment 300 may be performed on a client device to identify malware or other applications operating on the client device. When malware or other unwanted applications are detected, the client device may take various actions. The actions may include stopping the application, slowing down the application, monitoring the application, or some other action. In some embodiments, some applications may be reprioritized or given increased bandwidth. Examples may include time sensitive applications, such as audio or video conferencing.

Embodiment 300 may be performed on a gateway device to identify various applications operating within a network. The gateway device may identify malware or other unwanted applications, as well as desirable applications. When the gateway device detects and unwanted application, the gateway device may take action that degrades or stops the unwanted application. When the gateway device detects a wanted and high priority application, the gateway device may increase the priority or bandwidth allocated to the application.

In block 302, network streams may be monitored.

In block 304, network streams with related packets may be identified. The network streams with related packets may be packets associated with a specific network session, for example. Each network session may be associated with a specific application.

For one of the network streams identified in block 304, a parameter vector may be generated in block 306. In some cases, the parameter vector may include statistics that may be measured or calculated from the network stream.

For each signature in the database in block 308, the vector may be analyzed in block 310 and the match probability may be determined in block 312. In embodiments where a signature is a decision tree, the analysis of blocks 310 and 312 may be quickly performed with a minimum of computational expense.

If the probability of a match between the parameter vector and the currently analyzed signature does not exceed a predefined threshold in block 314, the process may return to block 308 to process another signature. If the probability of a match does exceed the predefined threshold in block 314, the signature may be determined as a match and the loop may be exited in block 316.

After processing the signatures in block 308, if there is no match found in block 318, the process may return to block 302 to gather and process another network stream.

If there is a match in block 318, action may be taken based on the match in block 320. The action may include increasing or decreasing the performance of the network stream. Examples of increasing the performance may include increasing the priority, allocating more bandwidth, or other changes that may enable faster throughput. Examples of decreasing the performance may include lowering priority, lowering the transmission rates, throttling transmission, cutting off transmission completely, or other changes that limit or restrict network transmission.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a processor;
a network capture system that identifies network traffic for a first unknown application and creates a first vector comprising a plurality of communication parameters for said network traffic, said communication parameters comprising transport layer parameters; and
a network analyzer that compares said first vector to a plurality of predefined signatures to identify a first application as a probable match for said first vector.

2. The system of claim 1 further comprising:
a database comprising said plurality of predefined signatures;
said network analyzer that further:
receives a new predefined signature; and
adds said new predefined signature to said database.

3. The system of claim 1, said predefined signatures being a defined using decision trees.

4. The system of claim 3, said decision trees defining a conditional probability for identifying an application.

5. The system of claim 4 further comprising:
said network analyzer that identifies a network stream associated with said first application and changes the performance of said network stream.

6. The system of claim 5, said network analyzer that increases the performance of said network stream.

7. The system of claim 6, said network analyzer that increases the priority of said network stream.

8. The system of claim 5, said network analyzer that decreases the performance of said network stream.

9. The system of claim 8, said network analyzer that halts said network stream.

10. The system of claim 1, said predefined signatures being defined by a signature generator that:
receives a training set comprising a captured network communications for said first application; and
generates a decision tree as a predefined signature for said first application.

11. A method performed on at least one computer processor, said method comprising:
detecting a first network stream;
identifying a plurality of network packets from said first network stream, said plurality of network packets having at least one common characteristic;
determining a first vector for said plurality of network packets, said first vector comprising protocol elements comprising transport layer parameters; and
comparing said first vector to a plurality of predefined signatures to identify said plurality of network packets as being caused by a first application.

12. The method of claim 11, said at least one common characteristic comprising at least one of a group composed of:
a source port;
a destination port; and
a protocol type.

13. The method of claim 11, said protocol elements comprising network volume.

14. The method of claim 13, said network volume being at least one of a group composed of:
number of data bytes from source to destination;
number of data bytes from destination to source;
number of packets from source to destination; and
number of packets from destination to source.

15. The method of claim 11, said protocol elements comprising timing data.

16. The method of claim 15, said timing data being at least one of a group composed of:
active time;
idle time; and
inter-arrival time.

17. The method of claim 16, said timing data comprising at least a standard deviation for a timing metric.

18. The method of claim 11, said protocol elements comprising errors associated with said plurality of network packets.

19. A method performed on at least one computer processor, said method comprising:
creating a first network stream comprising network packets associated with a first application;
determining a first vector comprising protocol elements associated with said first network stream;
creating a decision tree comprising conditional probabilities from said first vector;
incorporating said decision tree into a signature for said first application;
transferring said signature to a monitoring system;
said monitoring system that performs a monitoring method comprising:
monitoring a live network stream;
identifies a plurality of network packets having at least one common characteristic;
generates a second vector representing said plurality of network packets;
analyzes said second vector using said decision tree to determine a match confidence;
compares said match confidence to a predetermined threshold to determine that said match confidence is above said predetermined threshold and determine that said first application generated at least some of said plurality of network packets.

20. The method of claim 19, said protocol elements comprising:
number of data bytes from source to destination;
number of data bytes from destination to source;
number of packets from source to destination;
number of packets from destination to source;
packet length;
inter-arrival time;
active time;
idle time; and
at least one error statistic.
